(19) United States
(12) Patent Application Publication
(10) Pub. No.: US 2023/0099250 A1
(43) Pub. Date: Mar. 30, 2023

(54) COMPACT, UNIPLANAR DIFFERENTIAL-FED TRANSPARENT FILTENNA

(71) Applicant: Chongqing University, Chongqing (CN)

(72) Inventors: Mingchun TANG, Chongqing (CN); Pengfei ZHOU, Chongqing (CN); Dajiang LI, Chongqing (CN)

(21) Appl. No.: 17/949,973

(22) Filed: Sep. 21, 2022

(30) Foreign Application Priority Data
Sep. 29, 2021 (CN) 202111150796.5

(51) Int. Cl. H01Q 9/04; H01Q 1/48

(52) U.S. Cl. CPC H01Q 9/0464; H01Q 1/48; H01Q 9/045; H01Q 9/0421

(57) ABSTRACT

Provided is a compact, uniplanar differential-fed transparent filtenna, comprising a dielectric substrate, and a metal ground plane attached to the dielectric substrate, wherein an avoidance slot is formed in the metal ground plane. A circular radiator is further attached to the dielectric substrate, a ring slot is formed in the circular radiator, shorting stubs are attached to the dielectric substrate on the two sides of the circular radiator, and the shorting stubs on the two sides are respectively connected to the ends of coplanar waveguide differential feedlines attached to the dielectric substrate on the two sides, and the other ends of the coplanar waveguide differential feedlines on the two sides are respectively connected to inner conductors of differential coaxial cables located on the side wall of the dielectric substrate, and outer conductors of the differential coaxial cables are connected to a bottom plate of the metal ground plane.

### CROSS-REFERENCE TO RELATED APPLICATION

This patent application claims the benefit and priority of Chinese Patent Application No. 202111150796.5, filed with the China National Intellectual Property Administration on Sep. 29, 2021, the disclosure of which is incorporated by reference herein in its entirety as part of the present application.

### TECHNICAL FIELD

The present disclosure relates to the field of filtennas, and in particular relates to a compact, uniplanar differential-fed transparent filtenna.

### BACKGROUND OF THE INVENTION

In recent years, filtennas with both functions of filters and antennas can provide significant advantages in a communication system, including, reducing the interconnection lengths and losses between the filter and the antenna can be reduced, and realizing the filtering response in the aspects of its reflection coefficient and realized gain. Compared with single-ended filtennas, the differential filtennas have the characteristics of harmonic suppression, symmetric radiation, and high common-mode suppression level, and are easy to be integrated with circuits and systems by avoiding the use of conversion devices such as baluns. However, most of these differential filtennas require multiple layers of substrates to obtain a satisfactory differential filtering performance. Such as configuration inevitably leads to a significant increase in the overall thickness and design complexity.

On the other hand, transparent antennas have an increasingly wide range of applications due to their abilities to send and receive electromagnetic signals without blocking the penetration of light, such as windshields, solar panels, monitors, and X-band satellites. The antenna is needed to satisfy the requirements of compactness, light weight, limited space, and high transparency.

### SUMMARY OF THE INVENTION

An objective of the present disclosure is to provide a compact, uniplanar differential transparent filtenna. The antenna can achieve a wider bandwidth under the smallest volume, and three radiation nulls may be generated on a realized gain curve to make the antenna have high out-of-band suppression levels. Meanwhile, the whole antenna also achieves a higher transparency.

The objective of the present disclosure is achieved through the technical solution as follows. The filtenna comprises a dielectric substrate, and a metal ground plane attached to the dielectric substrate, wherein an avoidance slot is formed in the metal ground plane.

A circular radiator is further attached to the dielectric substrate, a ring slot is formed in the circular radiator, and shorting stubs are attached to the dielectric substrate at two sides of the circular radiator. The shorting stubs on the two sides are respectively connected to the ends of coplanar waveguide differential feedlines attached to the dielectric substrate on the two sides, the other ends of the coplanar waveguide differential feedlines on the two sides are respectively connected to inner conductors of differential coaxial cables located on the side wall of the dielectric substrate, and outer conductors of the differential coaxial cables are connected to a bottom plate of the metal ground plane.

The circular radiator, the shorting stubs and the coplanar waveguide differential feedlines are all located inside the avoidance slot.

Further, the circular radiator is attached to the center position of the upper surface of the dielectric substrate, and the ring slot divides the circular radiator into an inside circular annular radiating patch and an outside circular annular radiating patch.

The shorting stubs each comprise a fan-shaped circular ring and two rectangular lugs connected to the two ends of the fan-shaped circular ring, and the other ends of the two rectangular lugs are connected to the metal ground plane. The central axis of the fan-shaped circular ring coincides with the central axis of the circular radiator.

The coplanar waveguide differential feedline is rectangular, the projection of the lengthwise central axis of the coplanar waveguide differential feedline in a vertical direction coincides with the projection of the lengthwise central axis of the dielectric substrate in a vertical direction, and one end of the coplanar waveguide differential feedline is connected to the middle of the fan-shaped circular ring.

Further, the avoidance slot comprises a circular avoidance slot for avoiding the circular radiator and the shorting stubs, and stepped avoidance slots located on the two sides of the circular avoidance slot for avoiding the coplanar waveguide differential feedlines. Each stepped rectangular slot comprises a first rectangular avoidance slot, one end of the first rectangular avoidance slot is connected to the circular avoidance slot, and the other end of the first rectangular receding slot is connected to one end of a second rectangular avoidance slot. The second rectangular avoidance slot penetrates through the metal ground plane.

The central axis of the circular avoidance slot coincides with the central axis of the circular radiator, and the lengthwise central axes of the first rectangular avoidance slot and the second rectangular avoidance slot coincide with the lengthwise central axis of the coplanar waveguide differential feedline.

Further, the metal ground plane, the circular radiator, the shorting stub and the coplanar waveguide differential feedline each are made of a copper mesh.

Further, the copper mesh has a thickness d of 2 μm, a line width L of 5 μm, and a line spacing W of 70 μm.

The dielectric substrate is made of Corning Eagle-XG glass with a relative dielectric constant of 5.27, a loss tangent tan of 0.001, a length sub-1 of 43 mm, a width sub-w of 33 mm, and a thickness H of 0.5 mm.

A spacing S₁ between the fan-shaped circular ring and the circular avoidance slot is 0.6 mm.

A spacing S₂ between the circular annular radiating patch and the fan-shaped circular ring is 1.4 mm.

The circular radiator has a radius R₂ of 11.2 mm, the circular annular radiating patch has a radius R₁ of 7.1 mm, and the ring slot has a width S₃ of 0.3 mm.

The coplanar waveguide differential feedline has a width W₁ of 2.4 mm.

The first rectangular avoidance slot has a width W₂ of 6.4 mm, and the second rectangular avoidance slot has a width W₃ of 5.1 mm.

The fan-shaped circular ring and the rectangular lug each have a width W₄ of 0.7 mm, and the fan-shaped circular ring as a fan-shaped included angle a of 163°.

By adopting the technical solution above, the present disclosure has the following advantages:

The present disclosure may achieve enough operating bandwidth under a smaller volume by only using a layer of metal, and three radiation nulls could be generated at two edges of passbands so as to obtain good roll-off rates and out-of-band suppression levels. Meanwhile, the glass is used as the substrate on the basis of the single-layer structure, and the copper mesh is electroplated to act as a conductive electrode to achieve the transparency performance, thereby achieving the higher transparency.

Other advantages, objectives, and features of the present disclosure will be set forth in part in the description which follows and in part will become apparent to those of ordinary skill in the art upon examination of the following or may be learned from practice of the present disclosure. Objectives and other advantages of the present disclosure can be realized and obtained from the following description and claims.

### BRIEF DESCRIPTION OF THE DRAWINGS

The accompanying drawings of the present disclosure are described as follows.

FIG. 1 is a three-dimensional view of an antenna structure in accordance with the present disclosure;

FIG. 2 is a top view of an antenna structure in accordance with the present disclosure;

FIG. 3 is a top view of a metal mesh employed by an antenna structure in accordance with the present disclosure;

FIG. 4 illustrates a relationship between a sheet resistance of a metal mesh structure employed by an antenna structure and a frequency in accordance with the present disclosure;

FIG. 5 is a plot of differential mode reflection coefficients |S_{dd11}| and the frequency for the antenna in accordance with the present disclosure;

FIG. 6 is a plot of an overall efficiency and the frequency for the antenna in accordance with the present disclosure;

FIG. 7 is a plot of a realized gain and frequency for the antenna in accordance with the present disclosure;

FIG. 8 illustrates radiation patterns of the E plane and the H plane of the antenna in accordance with the present disclosure.

### DETAILED DESCRIPTION OF THE EMBODIMENTS

The present disclosure is further described below with reference to the accompanying drawings and the embodiments.

In the drawings and this disclosure the following reference numbers designate the following elements: 1—dielectric substrate; 2—metal ground plane; 3—avoidance slot; 31—circular avoidance slot; 32—stepped avoidance slot; 321—first rectangular avoidance slot; 322—second rectangular avoidance slot; 4—circular radiator; 41—circular annular radiating patch; 42—circular annular radiating patch; 5—ring slot; 6—shorting stub; 61—fan-shaped circular ring; 62—rectangular lug; 7—coplanar waveguide differential feedline; 8—differential coaxial cable.

In the description of the embodiments of the present disclosure, it needs to be understood that the orientation or positional relationship indicated by terms “center”, “longitudinal”, “transverse”, “upper”, “lower”, “front”, “back”, “left”, “right”, “vertical”, “horizontal”, “top”, “bottom”, “inside” and “outside ” is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. Furthermore, the terms “first”, “second” and “third” are used for descriptive purposes only and are not to be construed as indicating or implying relative importance or implying a number of the indicated technical features. In the description of the embodiments of the present disclosure, it needs to be noted that, unless expressly specified and limited otherwise, the terms “connected,” “connection,” should be understood broadly, e.g., either fixed connection, detachable connection, or integral connection; either mechanical connection or electrical connection; either direct connection or indirect connection via an intermediate medium. For those of ordinary skill in the art, the specific meaning of the above terms in embodiments of the present disclosure should be understood in specific cases.

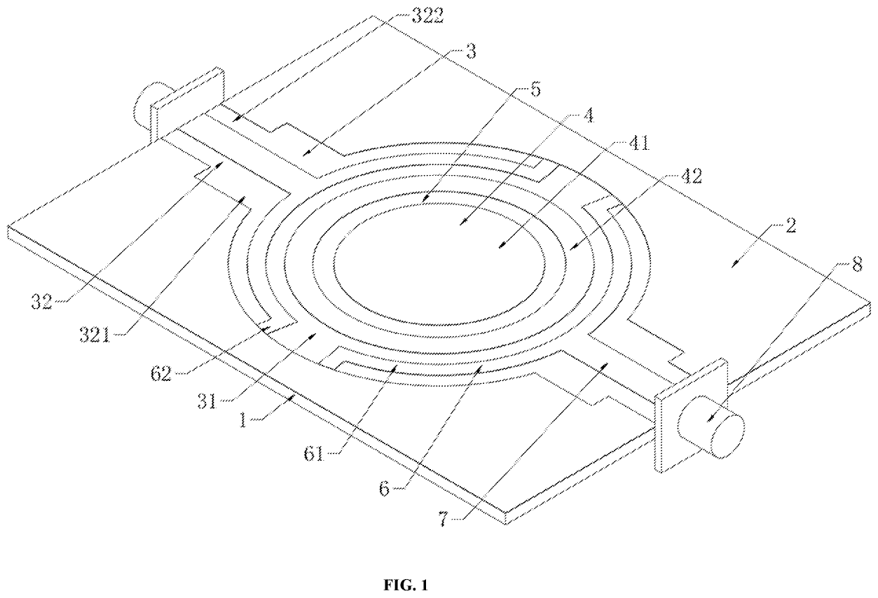

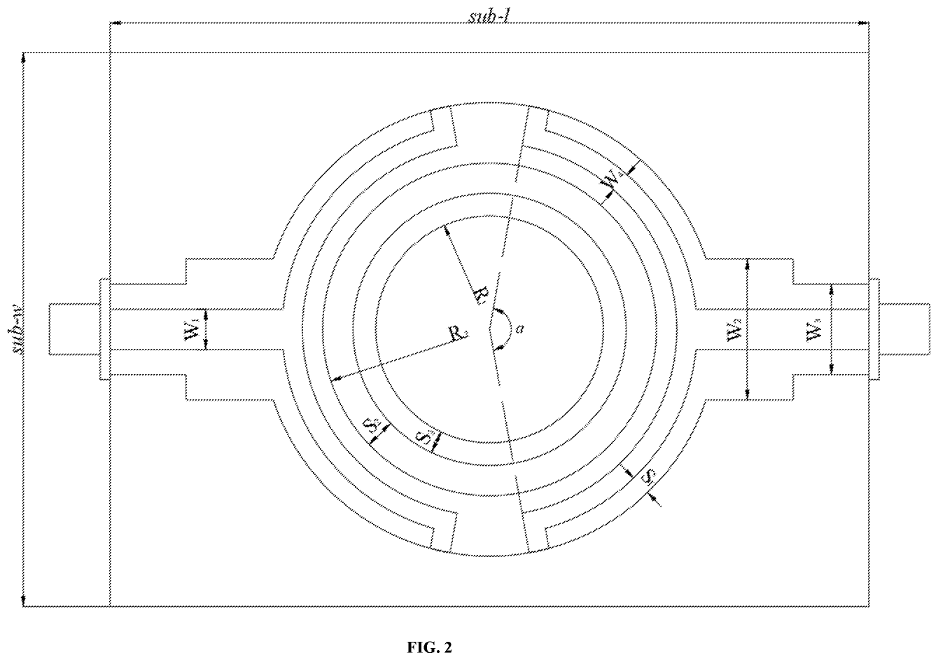

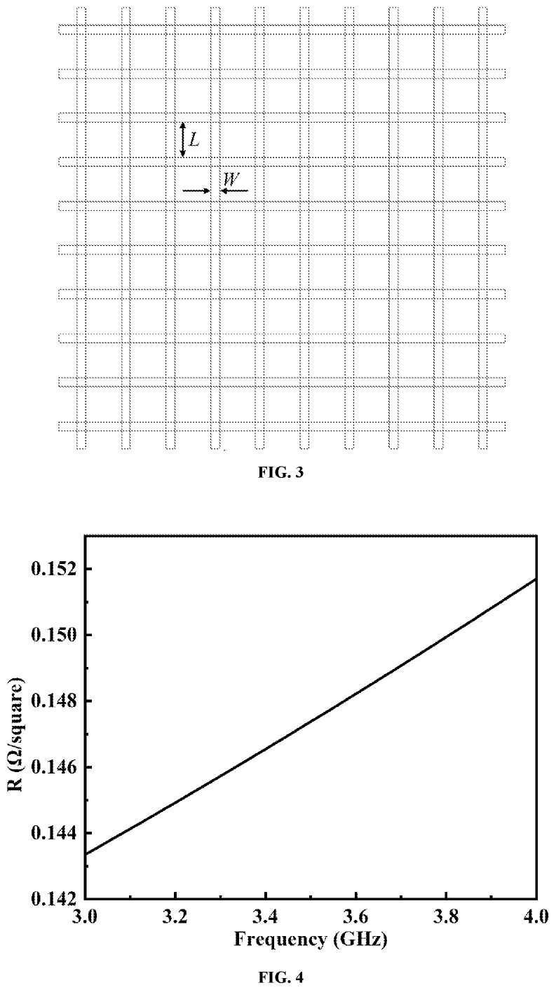

As shown in FIG. 1 to FIG. 3, a compact, uniplanar differential-fed transparent filtenna, comprises a dielectric substrate 1, and a metal ground plane 2 attached to the dielectric substrate 1, where an avoidance slot 3 is formed in the metal ground plane 2.

A circular radiator 4 is further attached to the dielectric substrate 1, a ring slot 5 is formed in the circular radiator 4, and shorting stubs 6 are attached to the dielectric substrate 1 at two sides of the circular radiator 4. The shorting stubs 6 on the two sides are respectively connected to the ends of coplanar waveguide differential feedlines 7 attached to the dielectric substrate 1 on the two sides, the other ends of the coplanar waveguide differential feedlines 7 on the two sides are respectively connected to inner conductors of differential coaxial cables 8 located on the side wall of the dielectric substrate 1, and outer conductors of the differential coaxial cables 8 are connected to a bottom plate of the metal ground plane 2.

The circular radiator 4, the shorting stubs 6 and the coplanar waveguide differential feedlines 7 are all located in the avoidance slot 3.

As an embodiment of the present disclosure, the circular radiator 4 is attached to the center position of the upper surface of the dielectric substrate 1. The ring slot 5 divides the circular radiator 4 into an inside circular annular radiating patch 41 and an outside circular annular radiating patch 42.

The shorting stubs 6 each comprise a fan-shaped circular ring 61 and two rectangular lugs 62 connected to the two ends of the fan-shaped circular ring 61, and the other ends of the two rectangular lugs 62 are connected to the metal ground plane 2. The central axis of the fan-shaped circular ring 61 coincides with the central axis of the circular radiator 4.

The coplanar waveguide differential feedline 7 is rectangular. The projection of the lengthwise central axis of the coplanar waveguide differential feedline 7 in a vertical direction coincides with the projection of the lengthwise central axis of the dielectric substrate 1 in a vertical direction, and one end of the coplanar waveguide differential feedline 7 is connected to the middle of the fan-shaped circular ring 61.

As an embodiment of the present disclosure, the avoidance slot 3 comprises a circular avoidance slot 31 for avoiding the circular radiator 4 and the shorting stubs 6, and stepped avoidance slots 32 located on the two sides of the circular avoidance slot 31 for avoiding the coplanar waveguide differential feedlines 7. Each stepped rectangular slot 32 comprises a first rectangular avoidance slot 321, one end of the first rectangular avoidance slot 321 is connected to the circular avoidance slot 31, and the other end of the first rectangular receding slot 321 is connected to one end of a second rectangular avoidance slot 322. The second rectangular avoidance slot 322 penetrates through the metal ground plane 2.

The central axis of the circular avoidance slot 31 coincides with the central axis of the circular radiator 4. The lengthwise central axes of the first rectangular avoidance slot 321 and the second rectangular avoidance slot 322 coincide with the lengthwise central axis of the coplanar waveguide differential feedline 7.

As an embodiment of the present disclosure, the metal ground plane 2, the circular radiator 4, the shorting stubs 6 and the coplanar waveguide differential feedlines 7 each are made of a copper mesh.

In accordance with this embodiment, the copper mesh is used to realize the transparency of the antenna. As shown in FIG. 4, a sheet resistance of 0.15 Ω/square is obtained for a waveguide simulation result of the copper mesh to be adopted. In the simulation of the antenna, the sheet resistance values of sheets of the coplanar waveguide differential feedline 7, the shorting stub 6, the circular radiator 4 and the metal ground plane 2 are set to be 0.15 ohm for simulation.

As an embodiment of the present disclosure, the copper mesh has a thickness d of 2 μm, a line width L of 5 μm, and a line spacing W of 70 μm.

As an embodiment of the present disclosure, the dielectric substrate 1 is made of Corning Eagle-XG glass with a relative dielectric constant of 5.27, a loss tangent tan of 0.001, a length sub-1 of 43 mm, a width sub-w of 33 mm, and a thickness H of 0.5 mm.

A spacing S₁ between the fan-shaped circular ring 61 and the circular avoidance slot 31 is 0.6 mm.

A spacing S₂ between the circular annular radiating patch 42 and the fan-shaped circular ring 61 is 1.4 mm.

The circular radiator 4 has a radius R₂ of 11.2 mm, the circular annular radiating patch 41 has a radius R₁ of 7.1 mm, and the ring slot 5 has a width S₃ of 0.3 mm.

The coplanar waveguide differential feedline 7 has a width W₁ of 2.4 mm.

The first rectangular avoidance slot 321 has a width W₂ of 6.4 mm, and the second rectangular avoidance slot 322 has a width W₃ of 5.1 mm.

The fan-shaped circular ring 61 and the rectangular lug 62 each have a width W₄ of 0.7 mm, and the fan-shaped circular ring 61 as a fan-shaped included angle a of 163°.

Based on above parameters, the high frequency structure simulator (HFSS) is used to perform simulated analysis on the performance parameters, such as reflection coefficients |S₁₁|, overall efficiency, gains and patterns of the designed compact uniplanar differential-fed transparent filtenna, with analysis results as follows:

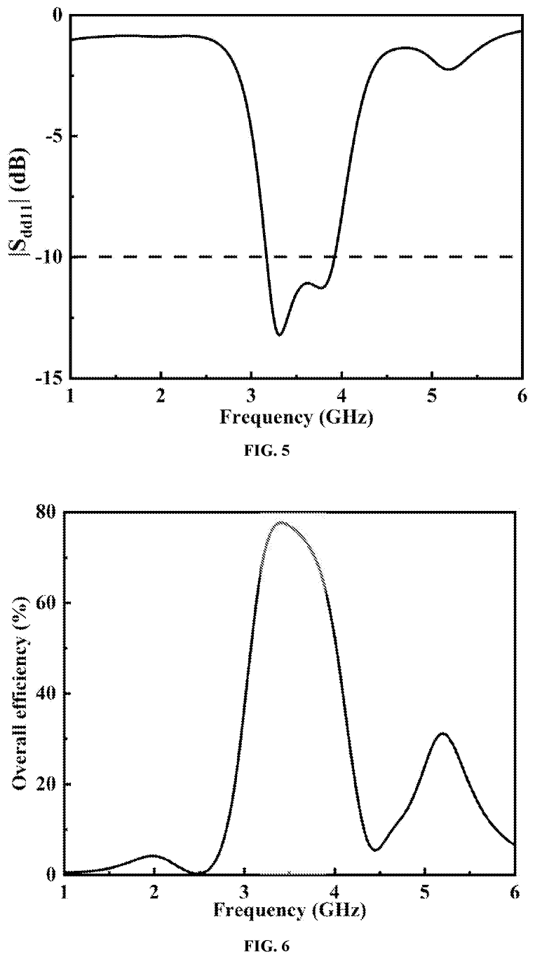

As shown in FIG. 5, the antenna has a −10 dB bandwidth of 3.17 GHz to 3.92 GHz, and an impedance bandwidth up to 21.16%.

As shown in FIG. 6, the antenna has an overall radiation efficiency of 60% and more.

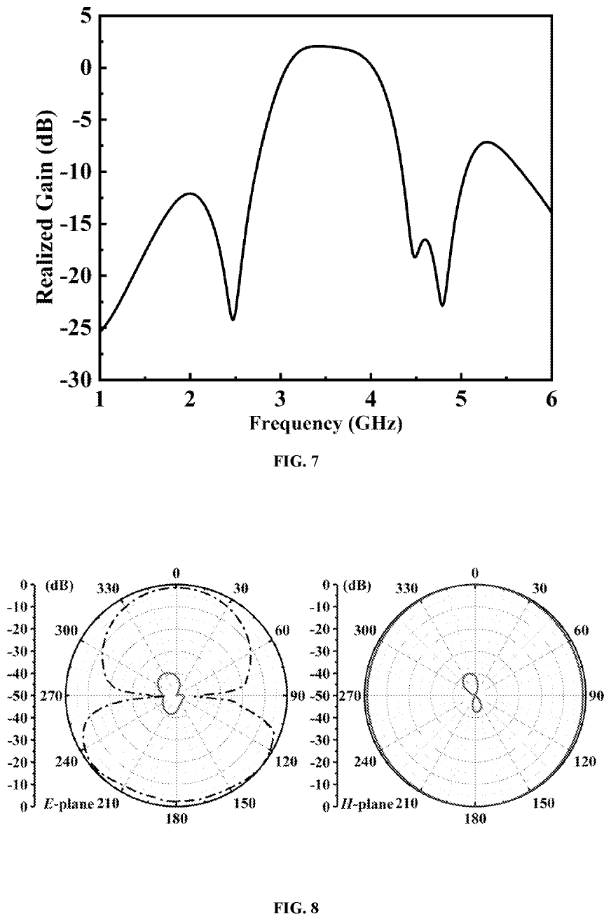

As shown in FIG. 7, the antenna has a peak realized gain of 2.18 dBi, and three radiation nulls are generated on the two edges of the operating band, which makes the antenna have sharp roll-off rates and high out-of-band suppression level.

As shown in FIG. 8, the cross-polarization level of the antenna is extremely low.

Finally, it should be noted that the above embodiments are only used to illustrate the technical solutions of the present disclosure rather than limiting the same. Although the present disclosure has been described in detail with reference to the foregoing embodiments, it should be understood by those of ordinary skill in the art that modifications or equivalent substitutions may still be made to specific embodiments of the present disclosure, and that any modification or equivalent substitution that does not depart from the spirit and scope of the present disclosure shall be encompassed within the scope of the claims of the present disclosure.

What is claimed is:

1. A compact, uniplanar differential-fed transparent filtenna, comprising a dielectric substrate (1), and a metal ground plane (2) attached to the dielectric substrate (1), wherein an avoidance slot (3) is formed in the metal ground plane (2);
a circular radiator (4) is further attached to the dielectric substrate (1), a ring slot (5) is formed in the circular radiator (4), and shorting stubs (6) are attached to the dielectric substrate (1) at two sides of the circular radiator (4);
the shorting stubs (6) on the two sides are respectively connected to the ends of coplanar waveguide differential feedlines (7) attached to the dielectric substrate (1) on the two sides, the other ends of the coplanar waveguide differential feedlines (7) on the two sides are respectively connected to inner conductors of differential coaxial cables (8) located on the side wall of the dielectric substrate (1), and outer conductors of the differential coaxial cables (8) are connected to a bottom plate of the metal ground plane (2); and
the circular radiator (4), the shorting stubs (6) and the coplanar waveguide differential feedlines (7) are all located in the avoidance slot (3).

2. The compact, uniplanar differential-fed transparent filtenna according to claim 1, wherein the circular radiator (4) is attached to the center position of the upper surface of the dielectric substrate (1), the ring slot (5) divides the circular radiator (4) into an inside circular annular radiating patch (41) and an outside circular annular radiating patch (42);
the shorting stubs (6) each comprise a fan-shaped circular ring (61) and two rectangular lugs (62) connected to both ends of the fan-shaped circular ring (61), the other ends of the two rectangular lugs (62) are connected to the metal ground plane (2), and the central axis of the fan-shaped circular ring (61) coincides with the central axis of the circular radiator (4); and
the coplanar waveguide differential feedline (7) is rectangular, the projection of the lengthwise central axis of the coplanar waveguide differential feedline (7) in a vertical direction coincides with the projection of the lengthwise central axis of the dielectric substrate (1) in a vertical direction, and one end of the coplanar waveguide differential feedline (7) is connected to the middle of the fan-shaped circular ring (61).

3. The compact, uniplanar differential-fed transparent filtenna according to claim 2, wherein the avoidance slot (3) comprises a circular avoidance slot (31) for avoiding the circular radiator (4) and the shorting stubs (6), and stepped avoidance slots (32) located on the two sides of the circular avoidance slot (31) for avoiding the coplanar waveguide differential feedlines (7); each stepped rectangular slot (32) comprises a first rectangular avoidance slot (321), one end of the first rectangular avoidance slot is connected to the circular avoidance slot (31), and the other end of the first rectangular receding slot (321) is connected to one end of a second rectangular avoidance slot (322); and the second rectangular avoidance slot (322) penetrates through the metal ground plane (2); and
the central axis of the circular avoidance slot (31) coincides with the central axis of the circular radiator (4), and the lengthwise central axes of the first rectangular avoidance slot (321) and the second rectangular avoidance slot (322) coincide with the lengthwise central axis of the coplanar waveguide differential feedline (7).

4. The compact, uniplanar differential-fed transparent filtenna according to claim 1, wherein the metal ground plane (2), the circular radiator (4), the shorting stub (6) and the coplanar waveguide differential feedline (7) each are made of a copper mesh.

5. The compact, uniplanar differential-fed transparent filtenna according to claim 4, wherein the copper mesh has a thickness d of 2 μm, a line width L of 5 μm, and a line spacing W of 70 μm.

6. The compact, uniplanar differential-fed transparent filtenna according to claim 3, wherein the dielectric substrate (1) is made of Coming Eagle-XG glass with a relative dielectric constant of 5.27, a loss tangent tan of 0.001, a length sub-1 of 43 mm, a width sub-w of 33 mm, and a thickness H of 0.5 mm;
a spacing S₁ between the fan-shaped circular ring (61) and the circular avoidance slot (31) is 0.6 mm;
a spacing S₂ between the circular annular radiating patch (42) and the fan-shaped circular ring (61) is 1.4 mm,
the circular radiator (4) has a radius R₂ of 11.2 mm, the circular annular radiating patch (41) has a radius R₁ of 7.1 mm, and the ring slot (5) has a width S₃ of 0.3 mm;
the coplanar waveguide differential feedline (7) has a width W₁ of 2.4 mm;
the first rectangular avoidance slot (321) has a width W₂ of 6.4 mm, and the second rectangular avoidance slot (322) has a width W₃ of 5.1 mm; and
the fan-shaped circular ring (61) and the rectangular lug (62) each have a width W₄ of 0.7 mm, and the fan-shaped circular ring (61) as a fan-shaped included angle a of 163°.
